(19) United States
(12) Patent Application Publication
(10) Pub. No.: US 2026/0202549 A1
(43) Pub. Date: Jul. 16, 2026

(54) MULTI-SATELLITE FAULT DETECTION AND EXCLUSION FOR INTEGRATED GNSS/INS NAVIGATION SYSTEMS

(71) Applicants: Samer Khanafseh, Tinley Park, IL (US); Birendra Kujur, Chicago, IL (US); Boris Pervan, Chicago, IL (US)

(72) Inventors: Samer Khanafseh, Tinley Park, IL (US); Birendra Kujur, Chicago, IL (US); Boris Pervan, Chicago, IL (US)

(73) Assignee: Illinois Institute of Technology, Chicago, IL (US)

(21) Appl. No.: 19/445,817

(22) Filed: Jan. 12, 2026

Related U.S. Application Data
(60) Provisional application No. 63/743,711, filed on Jan. 10, 2025.

(51) Int. Cl. G01S 19/20; G01S 19/39

(52) U.S. Cl. CPC G01S 19/20; G01S 19/393

(57) ABSTRACT

A method of and apparatus for fault detection and exclusion for ranging measurement systems. The method leverages a prior probability of measurement faults by constraining a threat space based on the prior probability of fault type and a fault magnitude. The ranging measurement system can be or include a global navigation satellite system (GNSS), an inertial navigation system (INS), terrestrial navigation, and/or LiDAR. Detecting faults uses an integrated auxiliary sensor and a Kalman filter. Identifying a faulty measurement signal is accomplished by deploying a sequence of detection windows starting at a specified frequency.

### CROSS REFERENCE TO RELATED APPLICATION

This application claims the benefit of U.S. Provisional Application, Ser. No. 63/743,711, filed on 10 Jan. 2025. The co-pending provisional application is hereby incorporated by reference herein in its entirety and is made a part hereof, including but not limited to those portions which specifically appear hereinafter.

### GOVERNMENT SUPPORT CLAUSE

This invention was made with government support under grant number MOA 693KA8-21-T-00027 awarded by Federal Aviation Administration. The government has certain rights in the invention.

### BACKGROUND OF THE INVENTION

Today, the Global Navigation Satellite System (GNSS) is widely used for position, navigation, and timing (PNT) applications. Due to its use in safety-critical applications such as aircraft landing, autonomous terrestrial vehicles, etc., a threat to GNSS integrity can endanger public safety. The integrity of GNSS systems can be compromised due to undetected satellite faults resulting in inaccurate positioning and/or timing. Receiver Autonomous Integrity Monitoring (RAIM) was developed as a method to detect GPS satellite faults leveraging the redundancy of multiple satellites. This has recently been extended to Advanced Receiver Autonomous Integrity Monitoring (ARAIM), which includes multiple constellations. Over time, use of auxiliary sensors such as an inertial measurement unit (IMU) was also proposed to aid in satellite fault detection. Modern navigation architectures typically utilize integrated Global Navigation Satellite System/Inertial Navigation System (GNSS/INS) systems for navigation; hence, no additional hardware implementation is required. Also, due to providing better accuracy, continuity, and protection levels, the integrated GNSS/INS KF architecture is favored over snapshot positioning methods such as the least-squares solution. Fault detection algorithms such as RAIM and ARAIM typically utilize solution separation between satellite subsets for detection. Solution separation measures the effect of the fault on the position domain (or any specific state(s)) directly. As a result, it does not require defining a specific temporal or spatial fault profile, making the evaluation of the system integrity risk valid for any type of fault. This eliminates the need to run many simulations to cover all types of faults the system may have. However, RAIM, and now ARAIM, both use snapshot navigation solutions (least squares, for example).

In integrated GNSS/INS systems with KF implementations, due to time correlation, it is not sufficient to remove a faulty sensor measurement at the time of detection. This is true because the fault (for example a slowly growing one) may have already corrupted the filter before detection. Also, to use solution separation parallel sub-filters, one for each fault hypothesis is needed for detection. Further, to maintain detection capability after exclusion of a fault, it would be necessary to continuously run parallel sub-filters for each sub-filter, thus greatly increasing the computational and memory cost as the number of fault hypotheses increases. This makes the solution separation method highly unlikely for practical applications. Other fault detection methods such as innovation-based detectors, the Euclidean distance method, and other different methods have been proposed. These, like solution separation, are general detection approaches that do not assume any prior knowledge of fault temporal behavior. They avoid the computational burden of KF solution separation approaches, but only at the expense of considerable degradation in detection performance over time.

An approach based on prior probability of satellite faults can be taken where the fault detector is optimized to detect a family of fault types. Table 1 shows the different fault modes and their probability categorization in the Minimum Operational Performance Standards (MOPS) for GNSS Aided Inertial Systems DO-384 by the Radio Technical Commission for Aeronautics (RTCA). These fault modes are derived from the observed faults in GPS constellation satellites to date. This standard provides a baseline for aviation equipment manufacturers to design and test their satellite FDE systems for certification.

TABLE 1

| | | Fault Rates |
|---|---|---|
| Fault Mode | Range | (10⁻⁵/hr/satellite) |
| Ramp | 3 cm/s-1 m/s | 10/15 |
| Step | 300-700 meters | 3/15 |
| Acceleration | 0.00005-0.025 m/s | 2/15 |

Integrated navigation systems with GNSS and auxiliary sensors such as IMU inside a filter architecture provides a more accurate and continuous navigation solution as compared to least-squares type. However, there is a continuing need for improved fault detection for these types of integrated systems which utilize current and past measurements.

### SUMMARY OF THE INVENTION

A general object of the invention is to address the limitations of current satellite FDE methods for integrated GNSS/INS navigation systems. The present invention addresses computational complexity while meeting integrity requirements by utilizing only a single Kalman filter (KF). The method of this invention leverages the prior probability of satellite faults by constraining the threat space based on prior probability of satellite fault type and magnitude as shown in Table 1.

The general object of the invention can be attained, at least in part, through a method of fault detection and exclusion for ranging measurement systems. The method includes leveraging a prior probability of measurement faults by constraining a threat space based on the prior probability of fault type and a fault magnitude. While the invention is generally described herein related to GNSS systems, the invention can also be applied to terrestrial navigation, feature based LiDAR (light detection and ranging), etc., and in general to any system that can provide a range measurement or observable to a known landmark, feature, beacon, transmitter, etc.

The invention further includes a method of multi-satellite fault detection and exclusion for integrated GNSS/INS systems. The method includes leveraging a prior probability of satellite faults by constraining the threat space based on the prior probability of satellite fault type and a fault magnitude.

In embodiments, detecting a fault uses an integrated auxiliary sensor and a Kalman filter. The Kalman filter is used to generally estimate position, and a test statistic is applied by this invention to the ranging measurements. Preferably, the invention identifies a faulty measurement signal by deploying a sequence of detection time windows starting at a specified frequency. The test statistic is applied on position data within the current window upon a fault (e.g., inconsistent measurement) detection. A length of the detection windows is determined as a function of a lower bound of a fault magnitude and a missed detection requirement.

In embodiments, an integrity risk given alert limit is provided with each detection window. Additionally or alternatively, the method provides a real-time protection level given integrity risk requirement with each detection window.

The invention further includes a method of fault detection and exclusion for ranging measurement systems, comprising: detecting a fault; identifying a faulty source for the fault; and excluding the faulty source from any location measurement.

The invention further includes a method of fault detection and exclusion for integrated GNSS/INS systems, including steps of: detecting a satellite fault; identifying a faulty satellite for the satellite fault; and excluding the faulty satellite from any location measurement. In embodiments, detecting the satellite fault uses integrated GNSS/auxiliary sensor measurements and applies a Kalman filter.

Identifying a faulty satellite can include deploying a sequence of detection windows starting at a specified frequency. A length of the detection windows is determined as a function of a lower bound of a fault magnitude and a missed detection requirement. The method can further include: providing an integrity risk given alert limit with each detection window; and/or providing a real-time protection level given integrity risk requirement with each detection window.

The invention further includes an apparatus for fault detection and exclusion in ranging measurement systems. The apparatus includes a fault detection, identification and exclusion (FDE) detector that includes a predetermined hypotheses test statistic and a predetermined sequence of detection windows starting at a specified frequency, wherein the hypotheses test statistic is applied to measurements obtained within each detection window. The apparatus can be embodied as hardware, middleware, or software, and can implement steps of the method discussed above.

Other objects and advantages will be apparent to those skilled in the art from the following detailed description taken in conjunction with the appended claims and drawings.

### BRIEF DESCRIPTION OF THE DRAWINGS

FIG. 1 illustrates an aircraft system for application of the invention.

FIG. 2 illustrates sequential windows for capturing fault onset according to embodiments of this invention.

FIG. 3 shows an example of deterministic effect of ramp fault on normalized carrier innovations of a single satellite.

FIG. 4 illustrates parametric PMD versus accumulation period N and single SV ramp fault rate.

FIG. 5 illustrates PMD versus accumulation period N for single satellite ramp and acceleration faults.

FIG. 6 illustrates PMD versus accumulation period N for dual satellite ramp fault.

FIG. 7 illustrates PMD versus accumulation period N for single satellite ramp fault (3 mm/s) for all satellites.

FIG. 8 illustrates PMD versus accumulation period N for single satellite ramp and acceleration versus polynomial detector.

FIG. 9 illustrates PMD versus accumulation period N for single and dual satellite ramp versus polynomial detector.

FIG. 10 illustrates an integrity risk for 6 SV.

FIG. 11 illustrates an integrity risk difference against lowest fault rate magnitude of 3 mm/s.

FIG. 12 illustrates a fault free integrity risk versus a single satellite fault integrity risk against ramp fault rate of 3 mm/s.

FIG. 13 illustrates a total integrity risk for different vertical alert limits (VAL) against a ramp fault rate of 3 mm/s.

FIG. 14 illustrates a vertical protection level (VPL) for an integrity risk requirement of 9.85×10-8 against ramp fault rate of 3 mm/s.

FIG. 15 illustrates sequential windows for detection and exclusion, according to embodiments of this invention.

FIG. 16 illustrates an identification and exclusion algorithm according to embodiments of this invention.

FIG. 17 illustrates an example detector performance for newly acquired faulty satellite according to embodiments of this invention.

### DESCRIPTION OF THE INVENTION

The current operating fault detection systems for GNSS satellites are implemented in a least-squares type of navigation system where the navigation solution is determined only using GNSS measurements at the current time (epoch). An integrated navigation system with GNSS and auxiliary sensors such as IMU inside a filter (such as a Kalman filter) architecture provides a more accurate and continuous navigation solution as compared to least-squares type. But a new fault detection method is required for these types of integrated systems which utilize current and past measurements. Existing detection methods for these integrated GNSS/AS Kalman filter systems (for example, solution separation method using subsets of satellites) require multiple parallel filters which greatly increases computational load. Furthermore, identification of faulty satellites and their exclusion requires even more additional parallel filters. Lastly, these detection methods are not optimal in the sense that they are not designed to detect any particular fault profile.

This invention solves the aforementioned limitations of GNSS satellite's fault monitoring systems for integrated GNSS and auxiliary systems within a filter architecture. The detector is designed to operate without the need for multiple parallel navigation filters. Also, the identification and exclusion algorithms operate optimally using information from the main filter. And finally, the detector can be optimized for unintentional GNSS fault modes that are the most likely to occur.

Embodiments of the invention are implemented as firmware, such as installed into existing navigation systems without the need for any additional hardware. If existing navigation systems only utilize GNSS then the invention may incorporate an auxiliary sensor along with a microprocessor which would be used for the firmware of the detector. Another potential implementation would be a complete system which includes a GNSS, and auxiliary sensor integrated to provide navigation solution with the detection implemented as firmware to the system.

The invention provides a signal fault detector that provides fault detection, identification and exclusion (FDE) of faulty measurements (e.g., from satellites). Unintentional faults on are monitored on a per fault hypothesis basis allowing optimal exclusion of faulty measurements once identified. The detector is capable of fault detection using a single integrated navigation filter. The identification and exclusion method utilizes consecutive windows of the detector without the need for running parallel navigation filters. This developed methodology can provide integrity risk and protection levels. The FDE algorithm is applicable to any primary ranging type of sensor used for positioning such GNSS, DME, etc.

In embodiments, a GNSS satellite signal fault detector of this invention is a multi-constellation, multi-satellite fault monitoring system which is capable of detecting satellite faults, identifying the faulty satellites and exclusion of those faulty satellites. The detector utilizes information from an integrated GNSS/auxiliary sensor (AS) and a Kalman filter to detect faults in the GNSS satellites. Single or multi-satellite fault hypothesis is used to formulate respective optimal test statistic which are monitored for faults. The detection performance is optimized for fault modes which are most likely to occur. These fault modes can be modeled using a polynomial. An optimal monitor run is also determined for the detector. Once a fault is detected, an identification and exclusion algorithm is executed with help of sequential window of detectors to optimally determine and exclude the faulty satellites with a probability of missed detection and integrity risk. The algorithm utilizes stored measurements and initial filter information to guarantee fault exclusion.

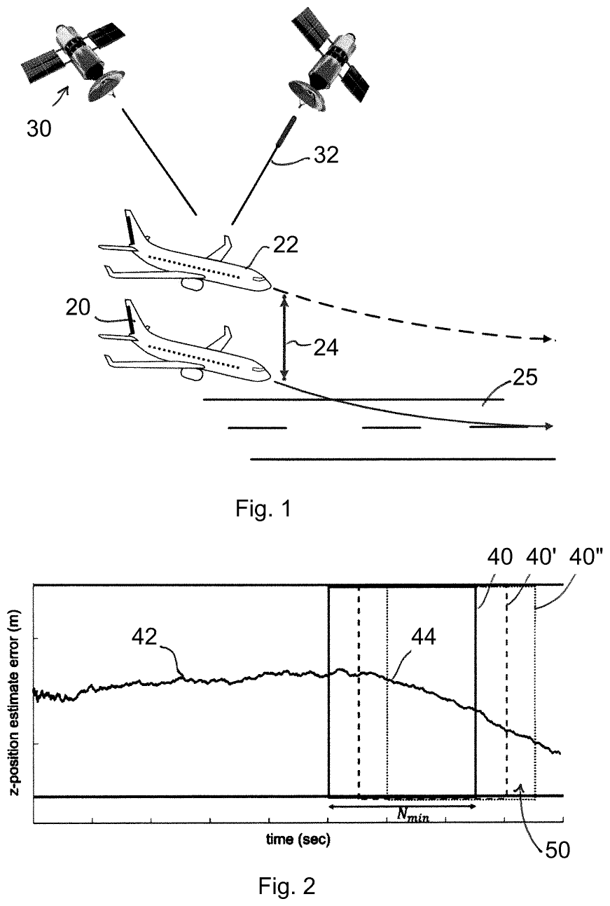

FIG. 1 shows a landing airplane 20 in communication with satellite system 30. Due to faulty satellite reading 32, the airplane's system incorrectly estimates the airplane position at 22, off by a distance 24. The error in this distance 24 is important as the airplane 20 seeks to land on runway 25. Embodiments of this invention detect faulty satellite readings, and once detection occurs, excludes the faulty satellite reading from system calculations.

In embodiments of this invention, the position data provided by the satellite system is checked using auxiliary sensor data and a Kalman filter, or equivalent state estimator. The detector of this invention desirably runs as a subsystem to the Kalman filter operation. In embodiments, the detector includes an estimation-correlation test statistic to identify faulty measurement data for exclusion. The fault is an inconsistent measurement relative to other obtained measurements. For example, for satellite systems, one or more of the many detected satellites at one time may be providing incorrect information. As another example, LiDAR may successfully detect several recognizable landmarks (e.g., buildings, statues for a ground vehicle) but mistake another landmark (e.g., a pedestrian or bucket repair truck for a sign or streetlight).

The estimation-correlation test statistic is desirably implemented recursively upon fault determination to determine which measurement source is to be excluded. When a fault is detected, the plurality of measurement sources (e.g., satellites), are recursively analyzed with each analysis occurring with one of the measurement sources removed from the calculation. If one source is removed, and the fault still occurs, the analysis continues with a different source removed. When the remaining sources test without the fault, then the faulty source is identified as the one currently removed. If the fault remains after recursively removing each source, then the analysis continues removing two sources at a time.

Embodiments of this invention include a sequential window detector for exclusion of one or more faulty satellite readings. The use of time windows for application of the estimation-correlation test statistic allows for shortening the readings to be examined, as compared to all measurements (e.g., since the vehicle began moving). The sequential window detector limits the time period(s) where the test statistic is evaluated, instead of implementing over a larger timeframe that can cause numerical issues. When running a longer timeframe, the detector's test statistic takes much longer to react and trigger to a fault that occurred long after the detector started. In addition, by evaluating the test statistic when the detector triggers, the fault can be presumed to have started inside the current window. Therefore, going back to the measurements at the beginning of the window and running different hypotheses by pulling candidate faulty measurements out will show which measurement(s) is/are the faulty measurement(s) by running the same test over this window. Once identified, the system can continue for the end of the window with the faulty measurement excluded, thus providing a clean safe output from the current point forward. The invention desirably deploys a sequence of detection windows starting at a specified frequency. In embodiments a length of each detection window is determined as a function of a lower bound of a fault magnitude and a missed detection requirement. The estimation-correlation test statistic can be recursively applied within/for each time window.

FIG. 2 illustrate sequential windows 40, 40′, 40″, etc. applied to a vertical position estimate error 42 (having ramp fault onset 44). A sequence of detection windows of length max(N_min) is determined to guarantee capture of fault onset 44. The data over each window 40 is stored to allow for exclusion of faulty satellite(s) once detected. Referring to FIG. 2, a minimum window length (Nmin) is determined for a given missed detection requirement. If Nₘᵢₙ is the length of window, N_{H} is the number of hypotheses, and f_{w} is the frequency of window, then a total number of windows is:

$${N}_{H} \frac{{N}_{min}}{{f}_{w}}$$

where N_{H}=nSV*monitored fault type. As a first example, if 18 satellites are monitored for a ramp (min 6 mm/s) for 500 epochs, every 100 epoch requires 90 windows. As a second example, if 45 satellites are monitored for a ramp (min 3 cm/s) for 20 epochs, every 10 epoch requires 90 windows.

A new detector window 40 of length Nₘᵢₙ starts with each new GNSS measurement. Each window 40 will operate until N epochs and if no fault is detected, the window 40 can be terminated. FIG. 2 shows a vertical position estimate error with a single satellite ramp fault 44 starting at 1200 seconds. When a fault is detected by one of the windows 40 it is guaranteed with a missed detection probability that the smallest fault did not start before that window 40. This allows for the exclusion of the faulty satellite measurements before the start of the detection window 40. In FIG. 2, a fault 50 is detected between Windows 40′ and 40″.

In embodiments, the faulty source (e.g., satellite) is excluded for the remainder of the travel. In other embodiments, the source may be recovered and allowed back into the positioning calculations. Such recovery can be obtained by, for example, running further subchannels of the test statistic to revalidate the source, or otherwise receiving updated information on the source (e.g., position correction updates).

The following provides more detail, without limitation, for a satellite fault estimator correlator detector of this invention. A sufficient GLRT test statistic is also derived with the associated missed detection, integrity risk, and protection level equations.

In an integrated tightly coupled GNSS/INS navigation system, a fault appearing in a satellite measurement will affect the KF first where both GNSS measurements and predicted measurements using INS are fused together. The random variable which represents this fusion is called the innovation vector where the elements represent each satellite observation, i.e., both code and carrier phase observations. A fault appearing in any satellite will first appear on its respective innovation. Appendix A describes the tightly coupled KF architecture used for this article. At any time k, the normalized fault-free innovation vector \tilde{γ}ₖ of the KF is:

$${\tilde{γ}}_{k} = {S}_{k}^{- \frac{1}{2}} ( {z}_{k} - {H}_{k} {\overline{x}}_{k} ) , \qquad ( 1 )$$

where S represents the innovation covariance matrix, z is the GNSS code and carrier phase measurement vector, H represents the observation matrix, and x̅ is the state estimate vector prior to measurement update.

The normalized innovations thus follow a normal distribution:

$${\tilde{γ}}_{k} ∼ 𝒩 ( 0 , I ) . \qquad ( 2 )$$

The fault-free normalized innovations over time are time-independent white Gaussian noise (WGN). In the faulted scenario the normalized innovation vector at time k is:

$${\tilde{γ}}_{k}^{f} = {\tilde{γ}}_{k} + {S}_{k}^{- \frac{1}{2}} ( {f}_{k} + {b}_{k} ) , \qquad ( 3 )$$

which follows a non-zero mean normal distribution:

$${\tilde{γ}}_{k}^{f} ∼ 𝒩 ( {S}_{k}^{- \frac{1}{2}} ( {f}_{k} + {b}_{k} ) , I ) , \qquad ( 4 )$$

where fₖ is the current epoch fault vector and bₖ is the cumulative effect of prior faults (f_{1:k-1}) on the current innovation vector. Note that superscript f is used to denote variables related to faulted state.

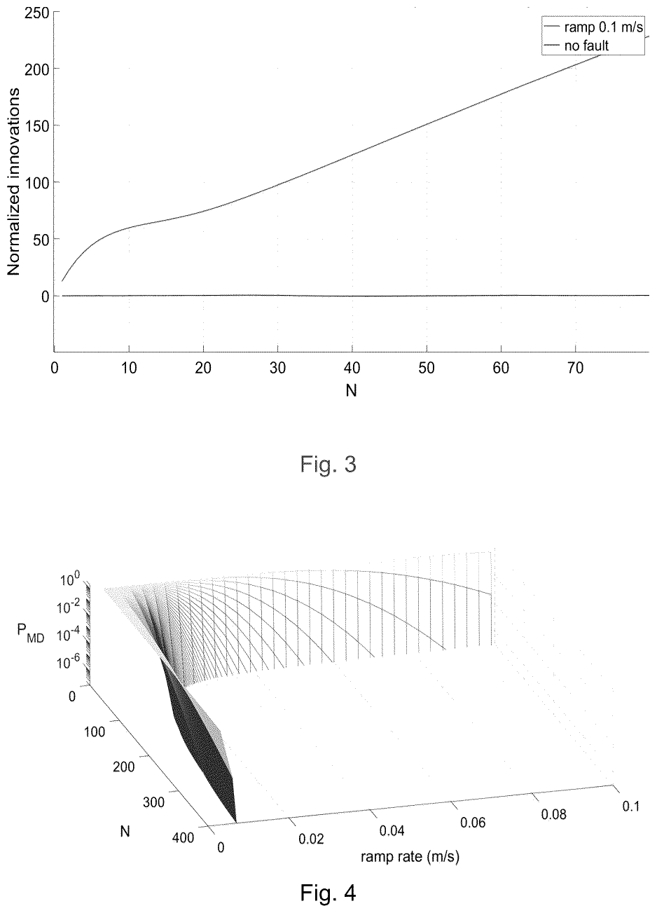

The fault vector can be represented with a fault subspace D and constant magnitude θ as fₖ=Dₖθ, then the cumulative term bₖ, for k>1 can be written as:

$${b}_{k} = - {H}_{k} {α}_{k} θ , \qquad ( 5 )$$

$$where :$$

$${α}_{k} = {Φ}_{k} [ {α}_{k - 1} + {K}_{k - 1} {B}_{k - 1} ] , \qquad ( 6 )$$

$$and :$$

$${B}_{k - 1} = {D}_{k - 1} - {H}_{k - I} {α}_{k - 1} \qquad ( 7 )$$

where K is the Kalman gain and Φ is the state transition matrix. The derivation for this cumulative term is in Appendix C. Using Equations (3) through (7), the deterministic effect of current and prior faults on normalized innovations can be obtained. As an example, FIG. 3 illustrates the effect of a ramp fault of magnitude 0.1 m/s on the normalized innovations for N epochs. Recall from Table 1 that the ramp fault has been the most observed fault mode for GPS constellation. At any time k the deterministic due to fault can be represented as:

$${S}_{k}^{- \frac{1}{2}} ( {f}_{k} + {b}_{k} ) = {M}_{k} θ , \qquad ( 8 )$$

where Mₖ is the transformed fault subspace. If the normalized innovations for exposure time N is observed, then the deterministic impact is:

$$= M θ = {[ {S}_{1}^{- \frac{1}{2}} ( {f}_{1} + {b}_{1} ) {S}_{2}^{- \frac{1}{2}} ( {f}_{2} + {b}_{2} ) … {S}_{N}^{- \frac{1}{2}} ( {f}_{N} + {b}_{N} ) ]}^{T} , \qquad ( 9 )$$

where M is the transformed fault subspace over the period N. Thus, Equation (3) for period N can be written as:

$${\tilde{γ}}_{1 : N}^{f} = {\tilde{γ}}_{1 : N} + M θ , \qquad ( 10 )$$

where

$${\tilde{γ}}_{1 : N}^{f}$$

is the normalized innovation time series when a fault is present and \tilde{γ}_{1:N} is the normalized innovation time series when no fault is present. In vector form this can be represented as:

$$[ \begin{matrix}{\tilde{γ}}_{1}^{f} \\ ⋮ \\ {\tilde{γ}}_{N}^{f}\end{matrix} ] = [ \begin{matrix}{\tilde{γ}}_{1} \\ ⋮ \\ {\tilde{γ}}_{N}\end{matrix} ] + [ \begin{matrix}{M}_{1} θ \\ ⋮ \\ {M}_{N} θ\end{matrix} ] , \qquad ( 11 )$$

The problem is formulated as signal detection of unknown amplitude (θ) in WGN (\tilde{γ}_{1:N}) This is a Bayesian linear model detection problem of unknown signal parameter (θ) additive to Gaussian noise (\tilde{γ}_{1:N}), with null hypothesis H₀: θ=0, and alternative hypothesis H₁: θ≠0. For this type of detection problem where signal parameter and sign are unknown, no uniformly most powerful (UMP) test exists and a generalized likelihood-ratio test (GLRT) is the standard approach.

Using the generalized likelihood-ratio test (GLRT), given two mutually exclusive hypotheses, H₀ and H₁, that for some N observation \tilde{γ}_{1:N} have conditional probability densities p₀ and p₁, the likelihood ratio given an arbitrary threshold T(N) is:

$$Λ ( {\tilde{γ}}_{1 : N} ) = \frac{{p}_{1} ( {\tilde{γ}}_{1 : N} \vert \hat{θ} , {H}_{1} )}{{p}_{0} ( {\tilde{γ}}_{1 : N} \vert {H}_{0} )} {{≷}_{{H}_{0}}}^{{H}_{1}} T ( N ) , \qquad ( 12 )$$

where \hat{θ} is the maximum likelihood estimate of θ under H1.

$$\hat{θ} = \frac{{\sum }_{k = 1}^{N} {\tilde{γ}}_{k} {M}_{k}}{{\sum }_{k = 1}^{N} {M}_{k}^{T} {M}_{k}} \qquad ( 13 )$$

In other words, a model of the deterministic impact of fault (M) is provided and θ is estimated assuming H₁. In vector notation the previous equation can be rewritten as:

$$\hat{θ} = {( {M}^{T} M )}^{- 1} {M}^{T} {\tilde{γ}}_{1 : N} \qquad ( 14 )$$

Expanding Equation (12) provides:

$$Λ ( {\tilde{γ}}_{1} , {\tilde{γ}}_{2} , … , {\tilde{γ}}_{N} ) = \frac{exp ( - \frac{1}{2} {\sum }_{k = 1}^{N} {( {\tilde{γ}}_{k} - {M}_{k} \hat{θ} )}^{T} ( {\tilde{γ}}_{k} - {M}_{k} \hat{θ} )}{exp ( - \frac{1}{2} {\sum }_{k = 1}^{N} {\tilde{γ}}_{k}^{T} {\tilde{γ}}_{k} )} {{≷}_{{H}_{0}}}^{{H}_{1}} T ( N ) \qquad ( 15 )$$

Taking the log on both sides obtains:

$$- \frac{1}{2} {\sum }_{k = 1}^{N} {( {\tilde{γ}}_{k} - {M}_{k} \hat{θ} )}^{T} ( {\tilde{γ}}_{k} - {M}_{k} \hat{θ} ) - {\tilde{γ}}_{k}^{T} {\tilde{γ}}_{k} {{≷}_{{H}_{0}}}^{{H}_{1}} ln T ( N ) \qquad ( 16 )$$

Simplifying:

$$- \frac{1}{2} {\sum }_{k = 1}^{N} ( - {\tilde{γ}}_{k}^{T} {M}_{k} \hat{θ} - {\hat{θ}}^{T} {M}_{k}^{T} {\tilde{γ}}_{k} + {\hat{θ}}^{T} {M}_{k}^{T} {M}_{k} \hat{θ} ) {≷}_{{H}_{0}}^{{H}_{1}} ln T ( N ) \qquad ( 17 )$$

Substituting Equation (13) for \tilde{γ}ₖ the above equation can be re-written as:

$$- \frac{1}{2} {\sum }_{k = 1}^{N} ( - {\hat{θ}}^{T} {M}_{k}^{T} {M}_{k} \hat{θ} - {\hat{θ}}^{T} {M}_{k}^{T} {M}_{k} \hat{θ} + {\hat{θ}}^{T} {M}_{k}^{T} {M}_{k} \hat{θ} ) {≷}_{{H}_{0}}^{{H}_{1}} ln T ( N ) \qquad ( 18 )$$

Simplifying again:

$$= - \frac{1}{2} {\sum }_{k = 1}^{N} ( - {\hat{θ}}^{T} {M}_{k}^{T} {M}_{k} \hat{θ} ) {≷}_{{H}_{0}}^{{H}_{1}} ln T ( N ) \qquad ( 19 )$$

Taking out \hat{θ} terms from the summation one gets (simplifying again):

$${\hat{θ}}^{T} ( {\sum }_{k = 1}^{N} {M}_{k}^{T} {M}_{k} ) \hat{θ} {≷}_{{H}_{0}}^{{H}_{1}} 2 ln T ( N ) \qquad ( 20 )$$

Equation (20) can be equivalently written defining a test statistic for period N as:

$${q}_{N} = {\hat{θ}}^{T} {M}^{T} M \hat{θ} {≷}_{{H}_{0}}^{{H}_{1}} 2 ln T ( N ) \qquad ( 21 )$$

This test statistic can be interpreted as the estimate \hat{θ} correlated against \tilde{γ}_{1:N} to see whether the assumed H₁ is true or not. Thus, the test statistic q_{N} can be rewritten as:

$${q}_{N} = {( {\tilde{γ}}_{1 : N} )}^{T} M \hat{θ} \qquad ( 22 )$$

Under fault-free conditions the test statistic is central Chi-squared distributed with p degrees of freedom, where \hat{θ} is of size p×1:

$${q}_{N} ∼ {𝒳}_{p}^{2} \qquad ( 23 )$$

The threshold

$${T}_{{𝒳}_{p}^{2}}$$

can thus be determined from the inverse CDF of the Chi-square distribution:

$${T}_{{𝒳}_{p}^{2}} = {F}_{{𝒳}_{p}^{2}}^{- 1} ( {P}_{F A} \vert p ) \qquad ( 24 )$$

where

$${F}_{{𝒳}_{p}^{2}}^{- 1}$$

is the inverse CDF of the Chi-square distribution with p degrees of freedom and P_{FA} is the probability of false alarm requirement. Detection occurs when the test statistic q_{N} exceeds the threshold

$${T}_{{𝒳}_{p}^{2}} .$$

In the presence of a fault with actual \hat{θ} magnitude, the test statistic q_{N} is non-central Chi-squared

$${χ}_{p}^{2} ( λ )$$

distributed with non-centrality parameter:

$$λ = {θ}^{T} {M}^{T} M θ \qquad ( 25 )$$

The probability of missed detection for this detector is:

$${P}_{MD} = {e}^{- λ / 2} {\sum }_{j = 0}^{∞} \frac{{( λ / 2 )}^{j}}{j !} γ ( \frac{p + 2 j}{2} , \frac{{T}_{{𝒳}_{p}^{2}}}{2} ) / Γ ( \frac{p + 2 j}{2} ) , \qquad ( 26 )$$

where

$${T}_{{𝒳}_{p}^{2}}$$

is the is the threshold as defined in Equation (24), γ(a, b) is the lower incomplete Gamma function as defined as:

$$γ ( a , b ) = {\int }_{0}^{b} {t}^{a - 1} {e}^{- t} dt , \qquad ( 27 )$$

and Γ(a) is the Gamma function: Γ(a)=γ(a, ∞). Thus, using Equation (26) the detector window length N required to detect a fault of certain magnitude \hat{θ} is quantified while satisfying the missed detection requirement.

There are several factors that can contribute to satellite fault detection in a KF architecture. First, the fault-free redundant satellites contribute to the fault detection and the higher the number of fault-free satellites, the faster the detection of faults. Second, the IMU dynamic model plays a role in fault detection since it provides measurements that are transformed into the range domain to be compared directly to satellite measurements. Also, the higher the grade of IMU, the faster the detection of satellite faults. It should be noted that the contribution of the IMU in fault detection is significant when the number of redundant satellites is smaller. Thus, although this work is for integrated GNSS/INS systems, similar implementation can be done for GNSS-only KF systems. Lastly, the GNSS error model dynamics, such as cycle integer ambiguity and clock bias error models, also contribute to the detection.

The KF provides a navigation solution in the form of state estimates for position, velocity, and attitude. State estimate error is the difference between the KF state estimate and the true state. The state estimate errors are normally distributed and are represented with the estimate error covariance matrix. Thus, the probability of the estimate error being within a specific bound or limit can be determined. These limits can be obtained from typical navigation performance requirements and require an alert in case the estimate error exceeds the limits. These so-called alert limits can be specified for both horizontal and vertical position.

A hazardous condition is defined when estimate error exceeds the alert limit. A fault in one or multiple satellites may cause incorrect estimation thus causing position estimate error to exceed the alert limit. To timely detect faults, a monitoring system comprised of a detector is deployed in the navigation system. In the presence of a fault, if the test statistic of the detector exceeds the threshold, the fault is detected. This is referred to as integrity risk monitoring.

Integrity risk in general is the probability of the occurrence of a hazardous condition without timely alert from the detector, thus leading to hazardous misleading information (HMI). Integrity risk is formally defined as the probability of estimate error exceeding the alert limit while the test statistic of the detector does not exceed the threshold. For integrated navigation systems, an integrity risk value is allocated which includes both fault-free and faulted integrity risk.

For single constellation (such as GPS) multiple satellite fault hypothesis, the integrity risk, also called probability of hazardous misleading information, P (HMI) can be written as,

$$P ( HMI ) = P ( \vert \hat{e} \vert > AL , {q}_{N} < {T}_{{χ}^{2}} \vert {H}_{0} ) P ( {H}_{0} ) + {\sum }_{i = 1}^{n} P ( \vert \hat{e} \vert > AL , {q}_{N} < {T}_{{χ}^{2}} \vert {H}_{i} ) P ( {H}_{i} ) + {\sum }_{j = 1}^{n} {\sum }_{k = 1}^{n} P ( \vert \hat{e} \vert > AL , {q}_{N} < {T}_{{χ}^{2}} \vert {H}_{j} ⋂ {H}_{k} ) P ( {H}_{j} ⋂ {H}_{k} ) + … ; j \neq k , \qquad ( 28 )$$

where the first term represents the fault-free integrity risk, the second term represents integrity risk due to single satellite fault, third term represents integrity risk due to dual satellite fault and so on. Also, |ê| is the magnitude of estimate error after measurement update, AL is the alert limit, n is the number of satellites, Hᵢ is the i^{th} satellite fault hypothesis, and P (Hᵢ) is the probability of i^{th} satellite fault. Note that H₀ represents the fault-free hypothesis.

The current time estimate error has been shown to be independent of the detector test statistic. Thus, the above equation is just the product of probabilities represented as

$$P ( HMI ) = P ( \vert \hat{e} \vert > AL \vert {H}_{0} ) P ( {q}_{N} < {T}_{{χ}^{2}} \vert {H}_{0} ) P ( {H}_{0} ) + {\sum }_{i = 1}^{n} P ( \vert \hat{e} \vert > AL \vert {H}_{i} ) P ( {q}_{N} < {T}_{{χ}^{2}} \vert {H}_{i} ) P ( {H}_{i} ) + {\sum }_{j = 1}^{n} {\sum }_{k = 1}^{n} P ( \vert \hat{e} \vert > A L \vert {H}_{j} ⋂ {H}_{k} ) P ( {q}_{N} < {T}_{{χ}^{2}} \vert {H}_{j} ⋂ {H}_{k} ) P ( {H}_{j} ⋂ {H}_{k} ) + … ; j \neq k , \qquad ( 29 )$$

The effect of fault on estimate error has also been determined, which is used in the first product term in the above equation. Thus, if x is the monitored state for integrity risk

$$P ( \vert \hat{e} \vert > A L ) = 2 Q ( \frac{A L - E {\{}^{x} \hat{e} \}}{{σ}_{{x}_{\hat{e}}}} ) \qquad ( 30 )$$

where Q-function is the complement of the standard normal cumulative distribution function, E{^{x}ê} is the expected value of the x state estimate error, and σₓ_{_{ê}}\hat{ } is the estimate error standard deviation of the monitored state x.

The second product term is just the probability of missed detection as shown in Equation (26).

$${P}_{M D} = P ( {q}_{N} < {T}_{{χ}^{2}} ) \qquad ( 31 )$$

Given a multi-satellite fault hypothesis, Equation (29) allows us to compute integrity risk if an alert limit (AL) requirement is provided. Alternatively, if integrity risk requirement is given, a protection level (PL) can be computed by substituting PL instead of AL and solving for PL. Protection level is defined as the bound within which state estimate error is guaranteed with the probability 1−P (HMI).

In the following, methods to formulate a multi-satellite fault hypothesis with standard fault profiles as stated in Table 1 are described. Then the formulation for a polynomial fault profile is generalized.

For a multiple satellite fault hypothesis it can be assumed that all fault onset times are coincident. Considering the fault profiles as stated in Table 1 which are step, ramp, and acceleration. To generate the test statistic, first the fault profile is formulated. In the multi-satellite fault hypothesis a subset ST of satellites is chosen that could have a step fault, another subset RM that could have a ramp fault, and another separate satellite subset AC for acceleration faults such that ST∩RM∩AC=Ø. For J-satellite fault hypothesis there will be J fault magnitudes (θ) to be estimated. Thus, the fault vector at any time k for n number of satellites in-view is:

$${f}_{k} = {\underbrace{[ \begin{matrix}{}^{11} {d}_{k} & 0 & 0 & … & 0 \\ {}^{21} {d}_{k} & {}^{22} {d}_{k} & 0 & … & 0 \\ {}^{31} {d}_{k} & {}^{32} {d}_{k} & {}^{33} {d}_{k} & … & 0 \\ ⋮ & ⋮ & & ⋱ & ⋮ \\ {}^{n 1} {d}_{k} & {}^{n 2} {d}_{k} & {}^{n 3} {d}_{k} & ⋮ & {nJ}^{} {d}_{k} \\ {}^{11} {d}_{k} & 0 & 0 & … & 0 \\ {}^{21} {d}_{k} & {}^{22} {d}_{k} & 0 & … & 0 \\ {}^{31} {d}_{k} & {}^{32} {d}_{k} & {}^{33} {d}_{k} & … & 0 \\ ⋮ & ⋮ & & ⋱ & ⋮ \\ {}^{n 1} {d}_{k} & {}^{n 2} {d}_{k} & {}^{n 3} {d}_{k} & ⋮ & {}^{nJ} {d}_{k}\end{matrix} ]}}_{{D}_{k}} {\underbrace{[ \begin{matrix}{}_{1} θ \\ {}_{2} θ \\ ⋮ \\ {}_{J} θ\end{matrix} ]}}_{θ} ; \qquad ( 32 )$$

$${}^{i J} {d}_{k} = \{ \begin{matrix}1 , ∀ i ∈ ST \\ k , ∀ i ∈ RM \\ {k}^{2} , ∀ i ∈ AC \\ 0 , ∀ i ∉ \{ ST ⋃ RM ⋃ AC \}\end{matrix}$$

Note that the fault vector here is represented for both code and carrier measurements. The above equation can be used along with Equations (5), (6), (7), and (9) to generate the transformed fault subspace Mover a period N. The test statistic q can then be formulated using Equations (14) and (22).

Using the above equation for single satellite fault hypothesis (J=1) with single satellite fault magnitude ₁θ, the fault vector can be represented as:

$${f}_{k} = {\underbrace{[ \begin{matrix}{}^{11} {d}_{k} \\ {}^{21} {d}_{k} \\ ⋮ \\ {}^{n 1} {d}_{k} \\ {}^{11} {d}_{k} \\ {}^{21} {d}_{k} \\ ⋮ \\ {}^{n 1} {d}_{k}\end{matrix} ]}}_{{D}_{k}} {}_{1} θ ; \qquad ( 33 )$$

$${}^{i 1} {d}_{k} = \{ \begin{matrix}1 , ∀ i ∈ ST \\ k , ∀ i ∈ RM \\ {k}^{2} , ∀ i ∈ AC \\ 0 , ∀ i ∉ \{ ST ⋃ RM ⋃ AC \}\end{matrix}$$

It should be noted that for single satellite fault hypothesis ST, RM, and AC are mutually exclusive single element sets. For each satellite fault hypothesis a test statistic per fault profile is needed, thus a total of n×3 test statistic for n satellites and 3 fault profiles need to be monitored. Similarly for dual-satellite fault hypothesis (J=2) Equation (32) becomes:

$${f}_{k} = {\underbrace{[ \begin{matrix}{}^{11} {d}_{k} & 0 \\ {}^{21} {d}_{k} & {}^{11} {d}_{k} \\ ⋮ & ⋮ \\ {}^{n 1} {d}_{k} & {}^{11} {d}_{k} \\ {}^{21} {d}_{k} & 0 \\ ⋮ & ⋮ \\ {}^{n 1} {d}_{k} & {}^{n 2} {d}_{k}\end{matrix} ]}}_{{D}_{k}} {{\underbrace{[ \begin{matrix}{}_{1} θ \\ {}_{2} θ\end{matrix} ]}}_{θ}}_{} ; \qquad ( 34 )$$

$${}^{i 1} {d}_{k} = \{ \begin{matrix}1 , ∀ i ∈ ST \\ k , ∀ i ∈ RM \\ {k}^{2} , ∀ i ∈ AC \\ 0 , ∀ i ∉ \{ ST ⋃ RM ⋃ AC \}\end{matrix}$$

If each fault profile is monitored and there is a multiple-satellite fault hypothesis, many test statistic would need to be formulated. To reduce the number of test statistic, a second order polynomial fault profile per satellite can be monitored instead of individually monitoring for step, ramp, and acceleration. This will reduce the observed number of test statistic by 3 times. The polynomial fault profile can be represented as a function of time step k:

$$f ( k ) = {θ}_{a c} {k}^{2} + {θ}_{r m} k + {θ}_{s t} \qquad ( 35 )$$

where θ_{ac}, θᵣₘ, θₛₜ, represent fault magnitudes of acceleration, ramp, and step, respectively. The polynomial fault profile not only considers for standard fault profiles as stated in Table 1 but also increases the threat space being monitored to anything that belongs to second order polynomial space. If J is the subset of satellites monitored for faults, then the fault vector can now be formulated as:

$${f}_{k} = {\underbrace{[ \begin{matrix}{}^{11} {d}_{k} & 0 & 0 & … & 0 \\ {}^{21} {d}_{k} & {}^{22} {d}_{k} & 0 & … & 0 \\ {}^{31} {d}_{k} & {}^{32} {d}_{k} & {}^{33} {d}_{k} & … & 0 \\ ⋮ & ⋮ & & ⋱ & ⋮ \\ {}^{n 1} {d}_{k} & {}^{n 2} {d}_{k} & {}^{n 3} {d}_{k} & ⋮ & {}^{nj} {d}_{k} \\ {}^{11} {d}_{k} & 0 & 0 & … & 0 \\ {}^{21} {d}_{k} & {}^{22} {d}_{k} & 0 & … & 0 \\ {}^{31} {d}_{k} & {}^{32} {d}_{k} & {}^{33} {d}_{k} & … & 0 \\ ⋮ & ⋮ & & ⋱ & ⋮ \\ {}^{n 1} {d}_{k} & {}^{n 2} {d}_{k} & {}^{n 3} {d}_{k} & ⋮ & {}^{nj} {d}_{k}\end{matrix} ]}}_{{D}_{k}} {\underbrace{[ \begin{matrix}{}_{1} θ \\ {}_{2} θ \\ ⋮ \\ {}_{J} θ\end{matrix} ]}}_{θ} ; {}^{iJ} {d}_{k} = \{ \begin{matrix}[ {k}^{2} k 1 ] & ∀ i ∈ J \\ 0 & ∀ i ∉ J\end{matrix} \qquad ( 36 )$$

$$where :$$

$${}_{i} θ = {[ {}_{i} {θ}_{ac} {}_{i} {θ}_{rm} {}_{i} {θ}_{st} ]}^{T} \qquad ( 37 )$$

Again, Equation (36) can be used along with Equations (5)-(7) and (9) to generate the transformed fault subspace M. The test statistic q_{N} can then be formulated using Equations (14) and (22).

The present invention is described in further detail in connection with the following examples which illustrate or simulate various aspects involved in the practice of the invention. It is to be understood that all changes that come within the spirit of the invention are desired to be protected and thus the invention is not to be construed as limited by these examples.

### Examples

The performance of the detector was evaluated for an example scenario where an aircraft is cruising at level flight using GNSS measurements and navigation grade IMU. The aircraft level flight was simulated to start from 41° 50′10″ N, 87° 37′30″ W with cruising speed of 454 knots at an altitude of 40,000 ft. The GNSS measurements were generated for a specific day using the GPS constellation (SC-159, 2020a). Dual frequency GPS code and carrier phase ionospheric-free measurements with a measurement frequency of 2 Hz were utilized. A total of n=6 satellites were in view with detector false alarm allocation at 10⁻⁵. Results were shown only for ramp and acceleration fault modes since the observed step faults are large enough in magnitude that they can be detected with other generic detectors.

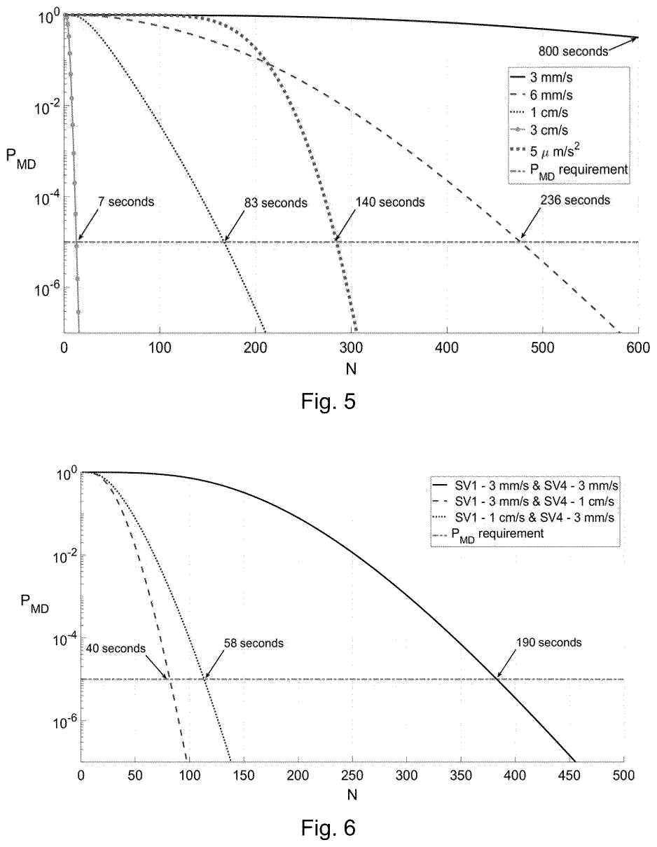

FIG. 4 illustrates the parametric results of probability of missed detection versus single satellite ramp rate and accumulation period N generated using Equation (26). This parametric result can be used to determine the accumulation period needed to meet the missed detection requirement given a fault magnitude. Recall that from Table 1 the lower bound of the threat space of each fault mode can be determined. Thus, using that lower bound the minimum accumulation period Nₘᵢₙ can be determined to meet the missed detection requirement. FIG. 5 illustrates the probability of missed detection versus different accumulation period N for single satellite ramp and acceleration faults. FIG. 5 represents the sliced view of FIG. 4 for different fault rates. The values of the minimum ramp and acceleration fault rates observed to date in the GPS constellation are 3 mm s and 5 μm/s², respectively (SC-159, 2020b).

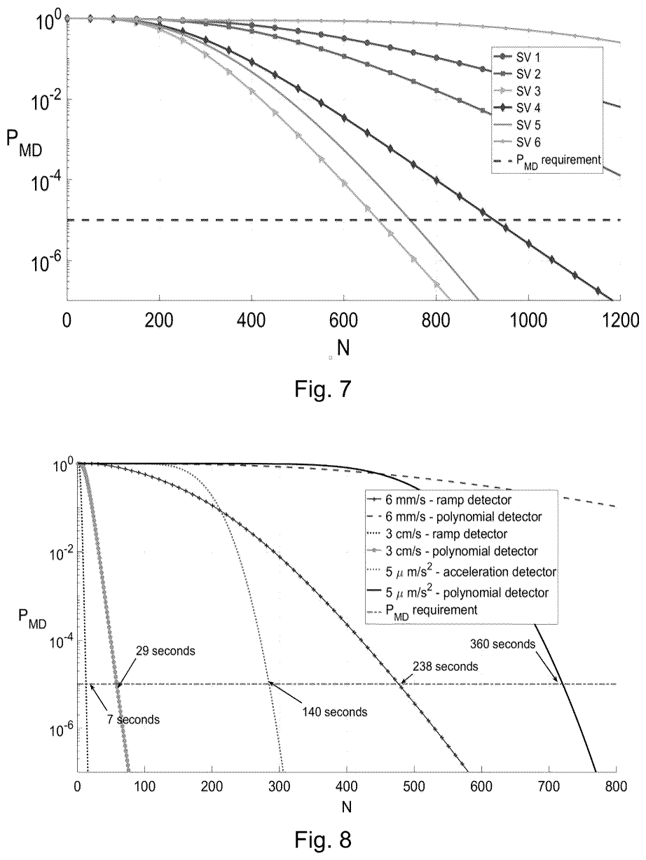

It should be noted that the recommended testing values in Table 1 for ramp fault mode are larger than the smallest ramp fault (3 mm/s) that has been observed. Also, the smallest observed ramp fault is the most difficult to detect. FIG. 6 illustrates the probability of missed detection versus the accumulation period N for dual satellite ramp fault hypothesis. Dual satellite ramp faults were injected on satellite vehicles (SV) 1 and 4 with different magnitudes. Dual satellite faults are faster to detect compared to single satellite faults. Also, detection performance varies with satellite geometry for the same fault magnitude. FIG. 7 illustrates the dependence of detection performance on satellite geometry explicitly. Here, a ramp fault was injected in each satellite individually and a test statistic was computed for each satellite fault hypothesis.

All the previous performance results were based on a detector with the hypothesis that the fault was ramp or acceleration and then those specific fault profiles were injected in satellites. In other words, the detector was formulated to be fault mode specific. Now the performance is compared when the injected fault is ramp or acceleration while the detector is generalized to estimate any quadratic polynomial fault profile.

FIG. 8 illustrates the comparative performance of polynomial detector against profile specific detector. FIG. 8 shows the probability of missed detection versus accumulation period N for single satellite ramp and acceleration faults. The performance of the polynomial detector is degraded as compared to the profile specific detector at the expense of increase in threat space that can be detected. Thus, instead of utilizing different hypotheses and test statistic for different fault profile types, a polynomial detector can capture all of them.

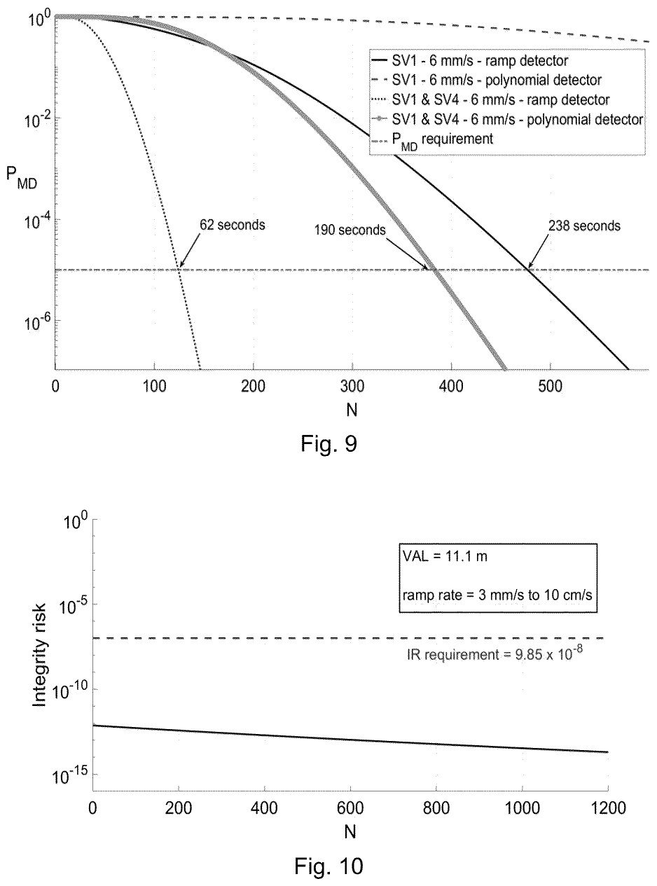

FIG. 9 illustrates the comparative performance of the polynomial detector against the profile specific detector for single and dual satellite ramp faults. Once the minimum accumulation period Nₘᵢₙ is determined based on lower bound of threat space, it can be used for integrity risk and protection level evaluation.

The fault rate for single satellite fault (P (Hᵢ)) is taken as 10⁻⁵ per satellite per hour (SC-159, 2020b). Thus, dual satellite fault rate (P (Hⱼ∩Hₖ)) is 10⁻⁵×10⁻⁵=10⁻¹⁰ per hour (SC-159, 2020b). The total integrity risk requirement P (HMI) is set at 10⁻⁷ and integrity risk due to more than two simultaneous satellite faults is considered to be negligible. Also, by conservatively equating, P (qN<T_{χ}2|H₀)=1 and P (H₀)=1. Estimate error is independent of test statistic, which allows the joint probability to be written as a product of two terms. Integrity risk Equation (29) can thus be written as:

$$P ( HMI ) = 1 {0}^{- 7} > P ( \vert \hat{e} \vert > AL \vert {H}_{0} ) + {\sum }_{i = 1}^{n} P ( \vert \hat{e} \vert > AL \vert {H}_{i} ) P ( {q}_{N} < {T}_{{χ}^{2}} \vert {H}_{i} ) 1 {0}^{- 5} + {\sum }_{j = 1}^{n} {\sum }_{k = 1}^{n} P ( \vert \hat{e} \vert > AL \vert {H}_{j} ⋂ {H}_{k} ) P ( {q}_{N} < {T}_{{χ}^{2}} \vert {H}_{j} ⋂ {H}_{k} ) 1 {0}^{- 10} ; j \neq k , \qquad ( 38 )$$

Dual satellite fault hypothesis is compensated by conservatively taking

$$P ( \vert \hat{e} \vert > AL \vert {H}_{j} ⋂ {H}_{k} ) = 1 and P ( {q}_{N} < {T}_{{χ}^{2}} \vert {H}_{j} ⋂ {H}_{k} ) = 1.$$

Thus, for n=6 satellites the integrity risk is compensated due to dual satellite fault hypothesis in P (HMI) as:

$$P ( HMI ) = 1 {0}^{- 7} > P ( \vert \hat{e} \vert > AL \vert {H}_{0} ) + {\sum }_{i = 1}^{n} P ( \vert \hat{e} \vert > AL \vert {H}_{i} ) P ( {q}_{N} < {T}_{{χ}^{2}} \vert {H}_{i} ) 1 {0}^{- 5} + {\sum }_{j = 1}^{n} {\sum }_{k = 1}^{n} P ( \vert \hat{e} \vert > AL \vert {H}_{j} ⋂ {H}_{k} ) P ( {q}_{N} < {T}_{{χ}^{2}} \vert {H}_{j} ⋂ {H}_{k} ) 1 {0}^{- 10} ; j \neq k , \qquad ( 39 )$$

In the following results the vertical position state are taken as the monitored state for fault and set the vertical alert limit (VAL) as an arbitrary fraction of 1 nautical mile (0.006×1 nmi=11.1 m). FIG. 10 illustrates the total integrity risk computed from Equation (39) for the ramp rate 3 mm/s to 10 cm/s. It should be noted that the detector utilized for integrity risk evaluation is fault profile specific. To get a bound on integrity risk with a fault profile it is necessary to determine whether the lowest magnitude fault is the worst case.

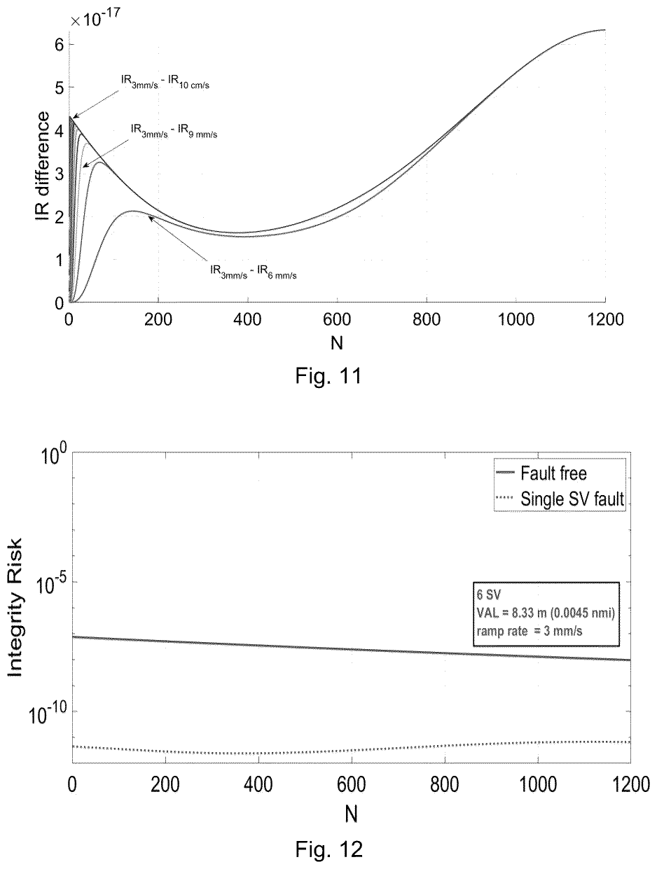

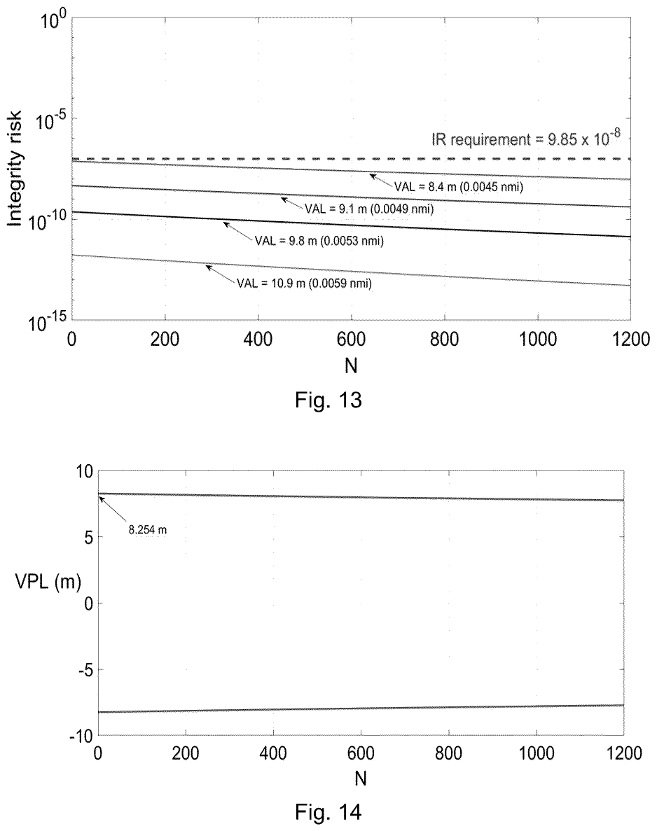

FIG. 11 illustrates the difference of integrity risk for fault magnitudes against lowest observed magnitude of 3 mm/s. It can be inferred from the figure that the smallest ramp rate produces the largest integrity risk, or in other words, integrity risk due to the smallest ramp rate will bound all the larger faults. Thus, if the detector accumulation period Nₘᵢₙ is set to meet the missed detection requirement for the lowest magnitude fault, it will ensure integrity risk bound due to all larger faults. FIG. 12 illustrates a comparison of the fault-free and single satellite fault integrity risk. The fault-free integrity risk dominates the total integrity risk. FIG. 13 illustrates the integrity risk for different vertical alert limits (VAL). For protection level evaluation integrity risk requirement of 9.85×10⁻⁸ is substituted, and one solves numerically for alert limit in Equation (39). FIG. 12 illustrates the achieved vertical protection level (VPL). It should be noted that the VPL is valid only if the detector is in operation for that duration.

Once detection occurs, the faulty satellite needs to be identified and excluded from the KF. An identification and exclusion algorithm is used that does not require a bank of parallel KFs. All previous performance evaluations of the detector assume that fault onset time and detector start time are coincident. Since fault start times cannot be known, consecutive detectors are used to tackle faults starting at any time, i.e., a new detector window of length N starts with each new GNSS measurement. The windows can be spaced out generously without degrading performance. This ensures that any fault will always have at least one detector with coincident start time. Each window will operate until N epochs and if no fault is detected can be terminated.

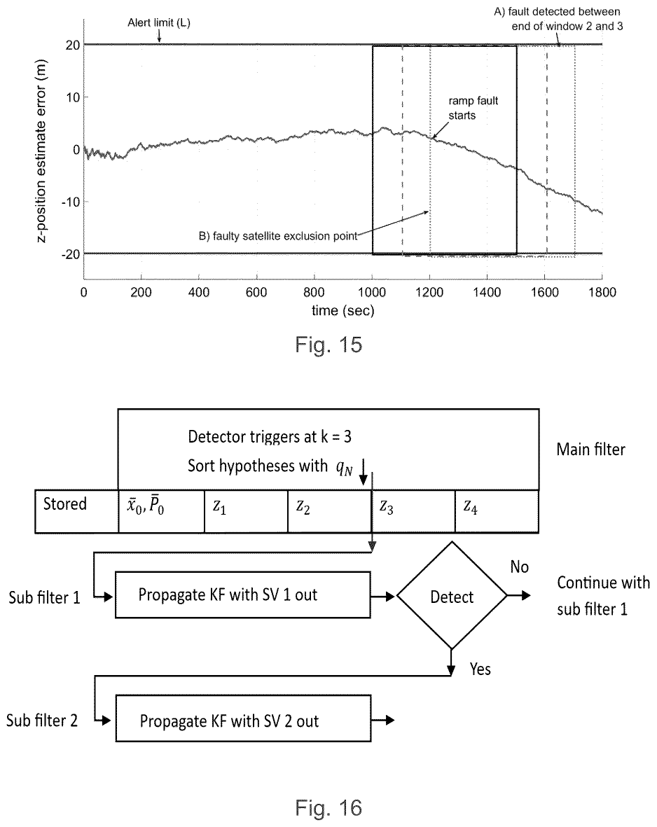

FIG. 2 illustrated the concept of sequential windows in a detector. The example figure shows vertical position estimate error with a single satellite ramp fault starting at 1200 seconds. The sequence of windows ensures that a fault starting at any time is completely captured by at least one of the windows. FIG. 15 illustrates the steps using the sequential windows. When any window declares a fault, it is asserted/presumed, within the stipulated missed detection probability by the monitor, that a minimum-magnitude fault could not have begun before that window's start time. Consequently, all measurements from any affected satellite(s) collected after the window start are discarded, while measurements obtained beforehand may be retained. This allows for the exclusion of the faulty satellite measurements before the start of the detection window.

A faulty satellite will typically trigger the test statistic associated with the hypothesis first but due to the recursive nature of KF, a fault on one satellite will trigger the test statistic of other hypotheses as well. Fault detection will only alert that one or more of the available satellites might be at fault. Thus, a faulty satellite identification process is required to isolate and exclude the faulty satellite.

FIG. 16 illustrates an algorithm of faulty satellite identification and exclusion, according to embodiments of this invention. The main navigation filter will typically run for the whole mission time with all the satellites in view. A sequence of detection windows is deployed starting at a specified frequency. At the start of the first detection window, initial conditions (states, covariances etc.) are stored and measurements within the windows. Note that the length of the detection window will be determined by the lower bound of the fault magnitude and the missed detection requirement. If the previous detection window did not trigger a fault, it can be said that the probability of the minimum magnitude fault not being detected at the start of the current window is P. At the start of every detection window, initial conditions (such as state x̅₀ and state error covariance P̅0) are stored. Marching forward in time, the GNSS and IMU measurements (z₀, z₁, z₂, . . . ) are also stored.

Once detection is triggered, for example at k=3 in FIG. 16, the hypotheses test statistic is sorted in descending order. The reasoning for this is that the faulty satellite will typically be the one with the largest test statistic. The satellite with the largest test statistic is excluded from the time the current detection window started. Using the fault-free initial conditions (x̅₀ and P̅0) and the stored measurements, the sub-filter which excludes the satellite with the largest test statistic is propagated.

Monitoring was performed to detect any faults inside this sub-filter and if no detection is triggered, it is confirmed that the excluded satellite was faulty, and navigation continues with the sub-filter. If the detector triggers, it means that the faulty satellite is still within the set of this sub-filter. The satellite with the next largest test statistic is excluded and another sub-filter is re-propagated with the remaining satellites. This process continues until a sub-filter is found that does not trigger any detection. This algorithm allows use of the sub-filter only when a fault detection is triggered, unlike other methods that always require running a bank of parallel KF.

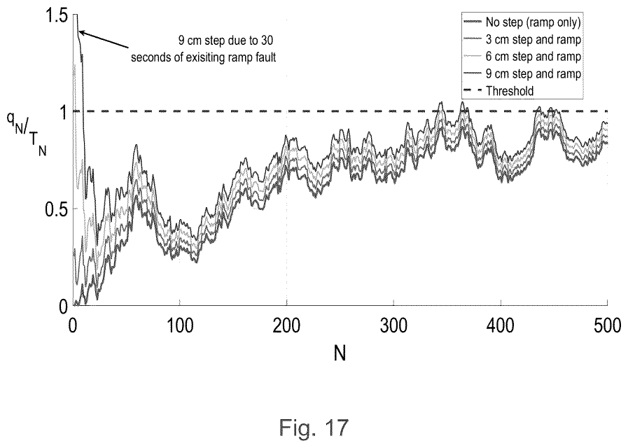

When a satellite is newly acquired there is a possibility that the satellite already had a fault. In such cases the fault profile for that satellite inside the detection window would look like a ramp fault with an offset. The offset would be dependent on the fault rate and time difference between fault onset and acquisition. FIG. 17 illustrates an example detection case for a newly acquired faulty satellite. A ramp fault of rate 3 mm/s was injected in the single satellite which was acquired with some time delay from monitor start time. The no step plot shows example detection result when the monitor start time is the same as the fault onset and satellite acquisition. The 9 cm step and ramp plot represent the case when the faulty satellite was acquired 30 seconds after the fault onset on the satellite. It can be observed from the plots that the step and ramp fault profiles will be detected faster than just the ramp fault profile. Thus, any satellite that already has a fault onset will be detected faster when satellite acquisition time is after fault onset time. For satellites that are now set without triggering the detector for any fault, there is also the possibility of them having undetected faults. Since measurements from these set satellites have been used, the undetected faults would then corrupt the navigation solution. A solution for this case is to exclude the satellite measurements that set until the last completed window that did not trigger.

The current existing fault detection methods for integrated GNSS/INS navigation systems typically comprise solution separation methods implemented for KF architecture. These types of methods require running a bank of parallel KF each corresponding to a fault hypothesis. Even for single satellite fault hypotheses with use of multi-constellation, running parallel KF for each hypothesis will be computationally expensive and is highly unlikely to be feasible for practical applications. The proposed FDE method of this invention relies on single KF and although with each additional monitored fault mode and monitor window the computational load increases, it still is more efficient and offers a lot more flexibility as will be discussed further. For this analysis wit was assumed that only single satellite faults and computation load comparison is done for the fault detection part of the FDE algorithm. The most computationally demanding part of a KF solution separation method is the bank of parallel KF, hence for this analysis the computational load due to the solution separation FDE algorithm can be ignored.

For the estimator-correlator detector of embodiments of this invention, there are three parts that contribute towards the computational load: first, the single KF; second, the FDE algorithm that requires hypotheses test statistic formulation; and finally, the sequential windows. Depending on the hardware and software limitations that would utilize the satellite FDE algorithm, there could be two metrics that can be used to compare the algorithms. First is the number of floating-point operations per second that each algorithm requires and second is the maximum total memory allocation at any time. Due to unavailability of access to avionics navigation hardware and software, total run time is used as a comparison metric for the algorithms and benchmark it with Matlab software code in a personal computer. The same scenarios were used as described above for this analysis. The computer specifications used for bench-marking the algorithms are in Table 2.

For the KF solution separation algorithm given n satellites with the single satellite fault hypothesis, n+1 KF is needed for detection, which includes one full set KF (with all satellite measurements) and n sub-set KF (which have one satellite excluded). Thus, if t_{KF} is the time required to run a single KF, the total computational time of the KF solution separation algorithm is T_{SS}=(n+1)×t_{KF}.

For the estimator-correlator FDE algorithm to determine the total number of windows required N_{w}_{ₜₒₜₐₗ}, it required the frequency of detector windows f_{w}, the number of hypotheses N_{f}, and the length of each window Nₘᵢₙ. The length of detector window Nₘᵢₙ is determined from the lower bound of the fault threat space, i.e., lowest fault magnitude and type and the missed detection requirement. If n_{f-mode} is the number of fault modes monitored, then the number of hypotheses is N_{H}=n_{f-modes}×n.

TABLE 2

| Specifications | Value |
|---|---|
| CPU model | AMD Ryzen 7 PRO 5750 G |
| CPU base speed | 3.80 GHz |
| CPU cores | 8 |
| CPU logical processors | 16 |
| RAM total capacity | 16 GB |
| RAM generation | DDR4 |
| RAM clock rate | 3200 MT/s |

The total number of detector windows required was:

$${N}_{{w}_{total}} = \frac{{N}_{H} \times {N}_{min}}{{f}_{w}} \qquad ( 40 )$$

Now if t_{w} is the additional computation time due to each window, the total time of the estimator correlator algorithm is

$${T}_{E C} = {N}_{{w}_{total}} \times {t}_{w} + {t}_{K F} \qquad ( 41 )$$

Thus, the invention provides a single KF-based multi-satellite fault detection, identification, and exclusion algorithm for integrated GNSS/INS navigation systems. The prior probability information of satellite faults is leveraged to determine the fault threat space. The detector is optimized using GLRT to the threat space constrained by fault modes. Missed detection probability is derived for the detector along with integrity risk and protection level equations. The threat space is generalized to include the family of quadratic polynomial faults and quantify the minimum length of the detection window which would ensure the detection of faults larger than a specific magnitude. A satellite identification and exclusion algorithm is provided, which no longer requires a bank of parallel KF. A sequence of detection windows ensures satellite fault onset capture and optimal exclusion once faulty satellite(s) is identified.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A method of fault detection and exclusion for ranging measurement systems, the method comprising leveraging a prior probability of measurement faults by constraining a threat space based on the prior probability of fault type and a fault magnitude.

2. The method of claim 1, wherein the ranging measurement system comprises a global navigation satellite system (GNSS), an inertial navigation system (INS), terrestrial navigation, and/or LiDAR.

3. The method of claim 1, wherein detecting the fault comprises obtaining measurements from an integrated auxiliary sensor and applying a Kalman filter.

4. The method of claim 3, further comprising identifying a faulty measurement signal by deploying a sequence of detection windows starting at a specified frequency.

5. The method of claim 4, wherein a length of the detection windows is determined as a function of a lower bound of a fault magnitude and a missed detection requirement.

6. The method of claim 4, further comprising providing an integrity risk given alert limit with each detection window.

7. The method of claim 4, further comprising providing a real-time protection level given integrity risk requirement with each detection window.

8. The method of claim 3, further comprising:
determining a measurement fault with the Kalman filter;
excluding the measurement fault from the Kalman filter.

9. The method of claim 8 further comprising:
identifying a faulty measurement signal by deploying a sequence of detection windows starting at a specified frequency; and
applying a missed detection probability test when the faulty measurement signal is detected by one of the detection windows, wherein the missed detection probability determines that a smallest fault did not start before the one of the detection windows, thereby allowing for the excluding of the measurement fault before the start of the one of the detection windows.

10. The method of claim 8, further comprising:
sorting test statistics for measurements in descending order, wherein the measurement fault is presumed to have a largest test statistic;
excluding a measurement with the largest test statistic from a time a current detection window started;
applying a sub-filter using fault-free initial conditions and stored measurements, wherein the sub-filter excludes the measurement with the largest test statistic; and
continuing navigation using the sub-filter.

11. The method of claim 10, further comprising repeating a detection process if a fault is detected in the sub-filter, until a new sub-filter is determined without any fault detection.

12. A method of fault detection and exclusion for ranging measurement systems, the method comprising:
detecting a fault;
identifying a faulty source for the fault; and
excluding the faulty source from any location measurement.

13. The method of claim 12, wherein detecting the fault comprises analyzing measurements from an auxiliary sensor with a Kalman filter.

14. The method of claim 12, wherein identifying a faulty source comprises deploying a sequence of detection windows starting at a specified frequency, wherein a length of the detection windows is determined as a function of a lower bound of a fault magnitude and a missed detection requirement.

15. The method of claim 14, further comprising providing an integrity risk given alert limit with each detection window.

16. The method of claim 14, further comprising providing a real-time protection level given integrity risk requirement with each detection window.

17. The method of claim 12, wherein the ranging measurement system is a GNSS/INS system, and further comprising:
detecting a satellite fault;
identifying a faulty satellite for the satellite fault; and
excluding the faulty satellite from any location measurement.

18. An apparatus for fault detection and exclusion in ranging measurement systems, comprising:
a single Kalman filter; and
a fault detection, identification and exclusion (FDE) detector that includes a predetermined hypotheses test statistic and a predetermined sequence of detection windows starting at a specified frequency, wherein the hypotheses test statistic is applied to measurements obtained within each detection window.

19. The apparatus of claim 18, wherein a length of the detection windows is determined as a function of a lower bound of a fault magnitude and a missed detection requirement.

20. The apparatus of claim 18, further comprising:
an integrity risk given alert limit with each detection window; and/or
a real-time protection level given integrity risk requirement with each detection window.
